(19) United States
(12) Patent Application Publication
(10) Pub. No.: US 2021/0162350 A1
(43) Pub. Date: Jun. 3, 2021

(54) METHODS AND APPARATUS FOR DETERMINING A FOULING INDEX

(71) Applicant: KING ABDULLAH UNIVERSITY OF SCIENCE AND TECHNOLOGY, Thuwal (SA)

(72) Inventor: Noreddine GHAFFOUR, Thuwal (SA)

(21) Appl. No.: 17/266,006

(22) PCT Filed: Aug. 9, 2018
(86) PCT No.: PCT/IB2018/056017

§ 371 Date: Feb. 4, 2021

(51) Int. Cl. B01D 65/08; B01D 61/02

(52) U.S. Cl. CPC B01D 65/08; B01D 65/10; B01D 61/025

(57) ABSTRACT

A method for determining a fouling index ROFix in a filtration system includes supplying a liquid feed across a filtration membrane; measuring an initial filtrate flow rate Q₀ of the liquid feed using a cross-flow filtration mode; measuring filtrate volumes Vᵢ at various corresponding times tᵢ using the cross-flow filtration mode; fitting a straight line for the filtrate volumes Vᵢ and the corresponding times tᵢ; and calculating a slope of the straight line. The slope or a parameter related to the slope is the ROFix index, and wherein the cross-flow filtration mode allows the liquid feed to exit the filtration system.

### TECHNICAL FIELD

The present disclosure generally relates to determining the fouling index for a membrane, and more particularly to systems and methods for determining a filtration membrane's fouling index.

### BACKGROUND

Fouling is a major bottleneck of membrane filtration processes. Fouling of a membrane can occur when a cake or gel layer builds up on the membrane surface. This layer can disturb the flow distribution across a membrane and negatively affect the process performance of a membrane system. Negative consequences of membrane fouling can include a decrease in system output (in terms of product quantity and quality), an increase of energy consumption by the membrane system, and an increase in membrane cleaning frequency and/or replacement.

Inadequate pretreatment of a feed to the membrane filtration system can be a cause of fouling and often necessitates frequent cleaning to restore the product flux in the system and in the case of a desalination system salt rejection. This can result in excessive chemical cleaning costs, increased system downtime, and, in severe cases, permanent loss of performance, membrane degradation and shorter membrane life.

Precise prediction of fouling tendency by a fouling index is important for determining a proper course of pretreatment of the feed to ensure the steady operation of a reverse osmosis (RO) system, such as desalination plants. Pretreatment systems can be chemical, mechanical or a combination of them. A fouling index with reliable reproducibility and precision that can be implemented into a reverse osmosis system can be used for optimal operation of a RO system.

A fouling index that is currently used in the industry is the Silt Density Index (SDI). The SDI is an index extensively used in RO systems. The SDI is generally viewed as an indicator for potential fouling. The standard SDI test (ASTM D-4189) is convenient and simple, and can be performed routinely by plant operators even without special training. Unfortunately, this simple test is often found to be unreliable and unsuitable for predicting the propensity of a RO membrane to fouling. There is disagreement in the RO industry on the SDI usefulness and scientific validity.

Therefore, there is a need for a more precise evaluation index to predict fouling potential with regards to aspects of RO systems, such as feed water fouling potential for determining feed pretreatment. There also exists a need to monitor RO system performance with regard to the efficiency of RO pretreatment to ensure the steady operation of the RO systems. Accordingly, there is a need to address the aforementioned deficiencies and inadequacies of the SDI.

### SUMMARY

According to an embodiment, there is a method for determining a fouling index ROFix in a filtration system, the method including supplying a liquid feed across a filtration membrane; measuring an initial filtrate flow rate Q₀ of the liquid feed using a cross-flow filtration mode; measuring filtrate volumes Vᵢ at various corresponding times tᵢ using the cross-flow filtration mode; fitting a straight line for the filtrate volumes Vᵢ and the corresponding times tᵢ; and calculating a slope of the straight line. The slope or a parameter related to the slope is the ROFix index, and the cross-flow filtration mode allows the liquid feed to exit the filtration system.

According to another embodiment, there is a reverse osmosis fouling index (ROFix) device that includes a storing container storing a liquid feed to be filtered; a filtering container holding a filtration membrane to be tested for fouling, the filtering container being in fluid communication with the storing container; a flowmeter for measuring a flow rate of the liquid feed; a manometer for measuring a pressure at an inlet of the filtering container and at an outlet of the filtering container; and a processor connected to the flowmeter and the manometer and configured to calculate a ROFix index based on (i) an initial filtrate flow rate Q₀ of the liquid feed using a cross-flow filtration mode and (ii) plural filtrate volumes Vᵢ measured at various corresponding times tᵢ.

According to still another embodiment, there is a non-transitory computer readable medium including computer executable instructions, wherein the instructions, when executed by a processor, implement instructions for determining a fouling index ROFix in a filtration system as discussed above.

Other systems, methods, features, and advantages of the present disclosure for systems and methods for a filtration membrane fouling index will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a device for calculating the SDI index;

FIG. 2 depicts a Cake filtration model, representing the MFI index (slope of t/V vs V of the linear line);

FIG. 3 illustrates a general trend of a permeate flux vs time for dead-end (dash line)) and cross-flow modes;

FIG. 4 illustrates Sequential SDI, turbidity and MFI determination of different water quality feeds;

FIG. 5 illustrates a reverse osmosis fouling index (ROFix) device for determining the ROFix index based on a cross-flow mode;

FIG. 6A shows the ROFix validation for different feed temperatures and FIG. 6B shows the ROFix validation for different feed concentrations; and

FIG. 7A illustrates the fouling parameters K_{d1} and K_{bf} vs feed concentration, FIG. 7B illustrates a variation of a deposition parameter with an applied pressure, and FIG. 7C illustrates a variation of a slope and K_{bf} with the applied pressure;

FIG. 8 is a flowchart of a method for calculating the ROFix index; and

FIG. 9 is a schematic diagram of a device for calculating the ROFix index.

### DETAILED DESCRIPTION

Described below are various embodiments of the present systems and methods for a filtration membrane fouling index and/or indices. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

It is to be understood that, unless otherwise indicated, the present disclosure is not limited to particular types of methods and devices relating to reverse osmosis fouling indices, particular subjects (e.g., human, animal, plant or inanimate), and particular software[s] for post-processing and analysis, or the like, as such can vary. It is also to be understood that the terminology used herein is for purposes of describing particular embodiments only, and is not intended to be limiting. It is also possible in the present disclosure that steps can be executed in different sequence where this is logically possible.

Before discussing the novel fouling index for a filtration membrane, the existing SDI method and apparatus are discussed for understanding their limitations and also how these limitations are overcome by the novel fouling index. The SOI apparatus is known to give some variation in the value of SDI for the same kind of water. The membrane used with the SDI apparatus also fails to give a precise value of the SDI index when the measurements are conducted with membrane variation. In 1982, the SDI index has been standardized by ASTM 041 89-95 (American Society for Testing & Materials, USA). Since then, this index has undergone several minor revisions as a response to the criticism for its unreliability, empirical nature and inability to predict fouling for peculiar feed waters. As mentioned by ASTM, the SDI would vary with the membrane filter manufacturer so that the values obtained with filters from different membrane manufacturers cannot be comparable. Three-folds different SDI values were reported when comparing various hydrophobicity membrane materials. Other properties of the used membrane, such as pore size distribution, thickness, roughness of the membrane, and membrane resistance were studied and resulted in significant variation between material and manufacturers (even for membranes of different batches of the same manufacturer).

Although the SDI has been widely used for many years, its results are questionable. The SDI inaccurately measures the fouling potential of the RO feed water and produces an over/underestimation of the actual fouling. Actual RO plants experience severe fouling phenomena when exploiting low SDI values. In addition, low turbidity water and ultrafiltration (UF) pretreated water (using membranes with a mean pore size of 0.02 μm while the membrane used to measure SDI has a nominal pore size of 0.45 μm) has been found to have high SDI values, which indicate the peculiar phenomena behind this measurement. Along with the utilization of SDI as fouling index, doubts have been raised concerning the reliability of SDI in regard to predicting fouling occurrences in RO systems.

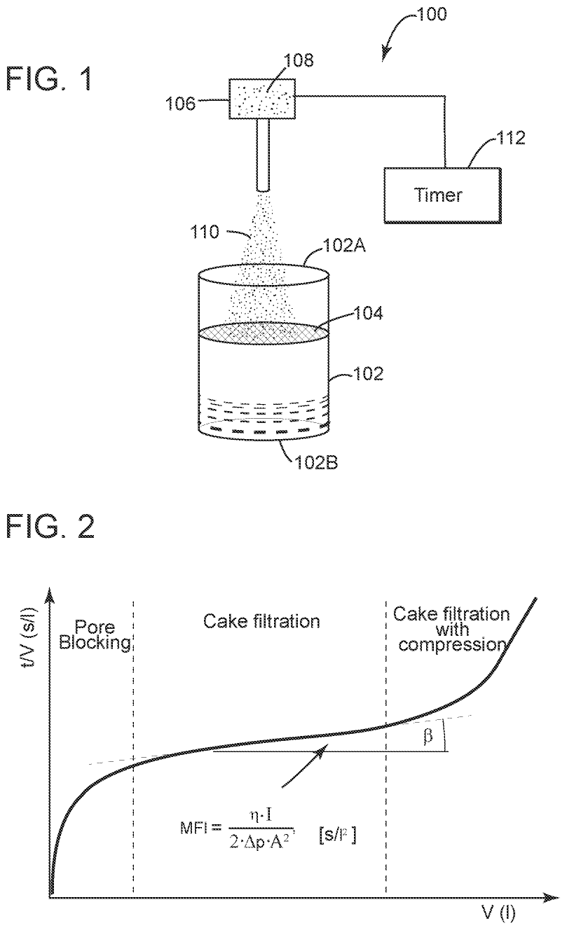

SDI calculations, as illustrated by equation (1) below, are essentially based on none of the classical filtration mechanism equations. The SDI test was developed by the DuPont Company at the end of the 1970s. It is calculated from the rate of membrane plugging measured with a dead-end filtration mode. The dead-end filtration mode is illustrated with reference to device 100 in FIG. 1. Note that device 100 schematically illustrates the principles for calculating the SDI. Device 100 includes a container 102 for measuring an amount of a filtrate (water or other fluid) that is filtrated by membrane 104. Container 102 has an open end 102A through which the filtrate enters and a closed end 102B where the filtered water is accumulated. Because the second end 102B is closed, i.e., the feed and the filtrate cannot pass beyond the container 102, this measurement mode is called a “dead-end mode.”

The filtrate (e.g., water with the various impurities 108) is provided from a source 106, which may be another container. A jet of filtrate 110 is released from source 106, with a certain pressure. This jet falls onto the membrane 104, and the filtered water is collected at the closed end 102B of container 102. A timer 112 is used to measure the time necessary for a certain volume of filtrate to pass through the membrane. In one application, the filtrate is passed through a 0.45 μm membrane filter at a constant applied pressure of 30 psi. Equation (1), which describes the SDI index is given by:

$${SDI}_{T} = \frac{\% {P}_{30}}{T} = \frac{1}{T} [ 1 - \frac{{t}_{1}}{{t}_{2}} ] \cdot 100 , \qquad ( 1 )$$

where % P₃₀ indicates the plugging rate of the membrane at 2.1 bar (30 psi) pressure. The time parameter t₁ is determined as the time required to collect the first 500 mL filtrate. After the filtration goes on for T (15 minutes), the time t₂ needed for collecting the final 500 mL of filtrate is measured with timer 112. Then, the SDI value is calculated based on equation (1) and presented in units of %/min.

The SDI method discussed above is not based on a filtration mechanism and does not have a linear correlation with a concentration of the colloidal matter in the filtrate. It is an empirical index based on the dead-end filtration test on a microfiltration (MF) membrane. A combination of fouling mechanisms can be assumed to be considered in SDI measurement, namely standard and partial blocking, which are likely to happen in such a MF process and not expected in RO filtration. This unmatched filtration mechanism within low and high-pressure membrane essentially makes the SDI as an improper way to predict the fouling of RO and NF operation.

A simple observation that indicates that the SDI is an inadequate tool to predict fouling is now discussed. Consider two different water qualities giving t1 of 18 s and 46 s, respectively, and t2 of 22 s and 50 s, respectively. These will give SDI values of 1.2 and 0.5 respectively, which means that the second case has a better water quality. However, the reality is the opposite. Also, the SDI has no correlation with the turbidity, which is questionable.

Based on equation (1), the maximum value of SDI is 6.67. When feed water is of bad quality, the maximum SDI values based on T=10 min and T=5 min become 10 and 20, respectively. However, these results are in practice meaningless.

The failure of the SDI index to accurately predict the fouling potential attracted several researchers to develop new fouling indices. In early 1980s, a modified fouling index (MFI) based on the cake filtration mechanism was proposed. The values of this index were obtained from the slope of linear curves of t/V (t is the time) versus accumulated filtrate volume (V) using the classical cake filtration model described in equation (2):

$$\frac{t}{V} = \frac{μ \cdot {R}_{m}}{Δ P \cdot {A}_{m}} + \frac{μ \cdot I}{2 Δ P \cdot {A}_{m}^{2}} \cdot V . \qquad ( 2 )$$

The obtained curve t/V versus V is shown in FIG. 2 and the MFI index is calculated based on equation (3):

$$MFI = \frac{μ \cdot I}{2 Δ P \cdot {A}_{m}^{2}} , \qquad ( 3 )$$

with μ being the water dynamic viscosity, Aₘ is the membrane surface active area, ΔP is the transmembrane driving pressure, Rₘ is the membrane resistance, and I is the fouling potential index.

The SDI equipment of FIG. 1 may be used to measure the MFI index. The MFI values are more predictive than the SDI despite it has no standard values for practical comparison.

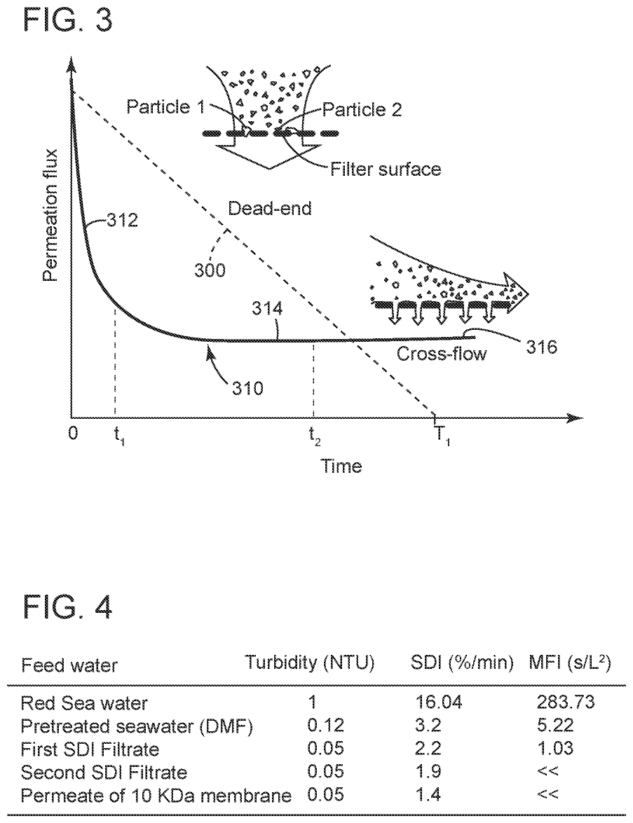

The MFI index is based on the cake filtration mechanism, has a linear correlation with the colloidal matter concentration and it can use membranes with different pore sizes, which is not the case for the SDI index. However, the MFI index is still based on the dead-end filtration mode, which is not the case for the operation of RO systems, which run under cross-flow filtration mode, as illustrated in FIG. 3. Note that FIG. 3 shows that a permeation flux 300 (i.e., the amount of filtrate that passes through the membrane 104 in FIG. 1) for the dead-end mode eventually becomes zero, at a time T1, while the permeation flux 310 for the cross-flow mode decreases, and then remains almost constant, but different from zero.

FIG. 4 shows that the turbidity, SDI index, and MFI index for different water quality feeds show no relation between the turbidity and the two indexes, which contradicts the theoretical models. Thus, neither the SDI index nor the MFI index appear to provide a good estimate of the fouling of a membrane operating under cross-flow mode.

Various modifications of the MFI have been tried as now discussed. Alteration of the filter pore size for the MFI method (to be 0.05 μm) has been tried after practical observations of the existing MFI indicate no correlation between the colloidal matter and the fouling and concluded that particles below 0.45 μm are probable the cause to the problem (see Boerlage, et al., 1997). Development of fouling indices based on pore size aiming at smaller particles to be captured by utilizing smaller pore size membranes yielded MFI-UF that uses a UF membrane (see Boerlage, et al., 2002) and MFI-NF that uses a nanofiltration (NF) membrane (see, Khirani, et al., 2006).

Hong et al. utilized flow field-flow fraction (FI-FFF) to overcome the above problem. The resulted FI-FFF analyses demonstrated that estimation of fouling tendency of feed water with the different foulants and salinity level were possible to be performed both qualitatively and quantitatively.

Yu et al. (2009) developed a new approach to evaluate the fouling potential in RO systems. This approach used a multiple membrane array system (MMAS) using a series of membranes with different pore sizes. The MFI index is measured during each separation representing particles, colloidal and organic removal through MF (0.45 μm), UF (100 KDa) and NF (10 KDa) membranes, respectively.

A combined fouling index (CFI) was also proposed by Choi et al. (2009) to include the contribution of particles, hydrophobic matters, colloids, and organics to RO/NF fouling. CFI uses a weighted combination of three kinds of MFI: MFI-HL, which relates to the usage of hydrophilic MF membrane, MFI-HP, which corresponds to hydrophobic MF membrane, and MFI-UF that consider a hydrophilic UF membrane.

In terms of the filtration system, existing MFI-UF at constant pressure mode filtration is improved by MFI-UF at constant flux. The problem was that the flux in constant pressure is significantly higher and does not represent the actual RO system. The MFI-UF constant flux is anticipated to nearly mimic fouling at the membrane surface, enhance fouling prediction accuracy and imitate actual RO operation (see Boerlage, et al, 2004 and Salinas et al., 2012).

A development of the MFI index in regard to the hydraulic system of filtration came up with a crossflow sampler CFS-MFI, with the belief of replacing the dead-end filtration MFI method. This method considers flux and crossflow velocities that mimic the character of RO filtration before measuring the MFI (see Sim et al., 2010, and Adham and Fane, 2008). In the CFS-MFI device, a CFS cell is placed upstream while the standard MFI device is installed downstream. Comparison and investigation of MFI-UF constant pressure, constant flux, and CFS-MFI has been performed along with the coupled effect resulted from the cake-enhanced osmotic pressure and colloidal fouling in RO using crossflow sampler (see Javeed et al., 2009 and Sim et al., 2011).

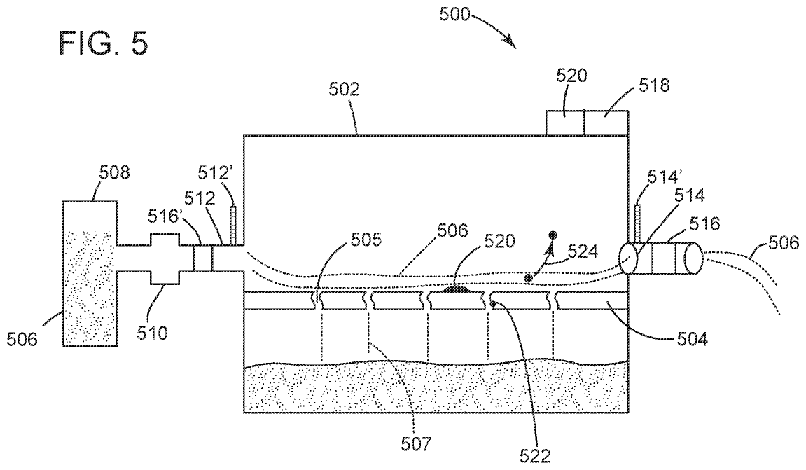

However, all the above approaches, including the MFI-UF at constant flux and CFS-MFI-UF, which use the standard MFI, still measure the fouling index based on the dead-end filtration mode while the RO operates under the cross-flow, which is illustrated in FIG. 3 and FIG. 5.

Unlike the dead-end mode filtration approach discussed above, in cross-flow filtration mode (at constant pressure), the permeate flux has three types of flow regimes. Initially, it has a transient regime 312 (see FIG. 3) with a decreasing permeate flux, then it attains a steady state 314 where the flux reaches a plateau, and then, in the third stage, the flux becomes independent of the applied pressure and it is called the limiting flux 316.

The reverse osmosis fouling index (ROFix) model used herein is based on this concept of cross-flow filtration mode, which mimics the real operational conditions of the RO process. The new ROFix index (to be discussed next) takes into account both the transient 312 and the steady state 314 flux regimes with their respective fouling and concentration polarization mechanisms and hydrodynamic conditions.

Theoretical classical filtration models which have been developed over the past decades (e.g., Herima, 1982 and Bolton et al., 2006) have been derived based on the use of classical relationships established for dead-end filtration, which are not always adequately correlated to the cross-flow experimental data because they account only for the decrease in the flux during transient period, which is based on the dead-end filtration concept. However, for a cross-flow filtration process, a steady state is present, which is achieved when the concentration layer reaches its equilibrium condition. This occurs when the flux of solute driving over the membrane surface, by convection, is the same as the back-transport away from the membrane due to cross-flow velocity and shear forces. The back-transport happens when the solute from the membrane flows back into the main stream of the water feed (i.e., the bulk suspension). Several mechanisms have been proposed to describe this back-transport of solute from the membrane to the bulk suspension. The cross-flow filtration mode has a totally different hydrodynamics than the dead-end filtration mode, which significantly affects the selective deposition of particles and colloids on the membrane surface and/or their suspension in the feed solution. Contrary to the dead-end filtration case, in cross-flow large particles are swept away from the membrane surface due to their higher back-transport while smaller particles, colloids or organics have a tendency to deposit on the membrane surface.

The novel ROFix index can be determined at constant pressure or constant flux modes (real operational conditions) using a small cross-flow flat sheet filtration cell at the desired conditions, though hollow fiber membranes can also be used. This cell or device can use membranes with different pore sizes (MF, UF, NF), and thus targeting different types of foulants by size exclusion (e.g., particulate/colloidal and organic). For a better accuracy, different pore size membranes can be used for the same water quality test, depending on the response of the flux or pressure evolution trends (run under constant pressure or constant flux, respectively).

A schematic of a novel ROFix device 500 that is used for determining the ROFix index is shown in FIG. 5. The ROFix device includes a housing 502 that holds a filtering membrane 504. A water feed 506, which may be stored in a container 508 is pumped with a pump 510 at an inlet 512 of the housing 502. A manometer 512′ may be placed at the inlet 512 to measure the inlet pressure. Water feed 506 then moves inside the housing 502, across the membrane 504, and exits at outlet 514. A manometer 514′ may be placed at the outlet 514 to measure the outlet pressure. This filtration mode is different from the dead-end filtration mode because of the presence of the exit 514. In this way, not all the water feed 506 is forced through the membrane 504. The water feed 506 in this device moves above and over the membrane while the filtrate 507 falls at the bottom of the housing. The filtered water that passes through the membrane accumulates at the bottom of the housing 502. A flowmeter 516 may be attached to the output 514 for measuring a flow of the water feed exiting the housing. Another flowmeter 516′ may be attached at the input 512 for evaluating a flow of the water feed entering the housing. ROFix device 500 may also include a processor 518 that receives readings from the one or more flowmeters and a memory 520 that stores these values and other commands. The processor 518 has also the capability to measure a given time interval, that is associated with the flowmeter(s) and perform various calculations for determining the ROFix index now discussed.

For the cross-flow filtration process illustrated in FIG. 5, the steady state (mode 314 in FIG. 3) is present when the concentration layer reaches its equilibrium condition. This occurs when the flux of solute 506 driving towards the membrane surface 504, by convection, is the same as the back-transport away from the membrane due to cross-flow velocity and shear forces. The back-transport in FIG. 5 would be from the membrane 504 to above the same membrane, as illustrated in the figure by the arrow.

The derivation of the ROFix index starts with Darcy's equation, which is used to express the permeation flux (J):

$$J = \frac{Δ P}{μ ( {R}_{m} + {R}_{d} )} = \frac{1}{A} \frac{dV}{dt} \qquad ( 4 )$$

where R_{d} is the deposit resistance. The deposit resistance R_{d} can be calculated as:

$${R}_{d} = \frac{a {X}_{o}}{A} V , \qquad ( 5 )$$

where X₀ is the volumic fraction of particles in the suspension, and α is the specific cake resistance per unit length of deposit.

Substitution and integration for a constant driving pressure through the membrane 504 results in:

$$\begin{matrix}\frac{t}{V} = \frac{1}{{Q}_{o}} + {k}_{d} V & ( 6 ) \\ with : & \\ {k}_{d} = \frac{α {X}_{o}}{2 A {Q}_{o} {R}_{m}} & ( 7 )\end{matrix}$$

where Q₀ is the initial filtrate flow-rate. This quantity can be measured with one or more of the flowmeters of the ROFix 500.

If t_{b} is the elapsed time during the total blocking step (i.e., the time when the pores 505 in FIG. 5 become totally blocked by the impurities from the water feed), equation (6) becomes, after changing the origin as suggested in Villaroel-Lopez et al., 1995:

$$\frac{t - {t}_{b}}{V - {V}_{b}} = \frac{1}{{Q}_{b}} + {k}_{d} ( V - {V}_{b} ) \qquad ( 8 )$$

where Q_{b} is the flow-rate at time t_{b} and V_{b} is the filtered volume (i.e., volume of fluid 507 in FIG. 5). The k_{d} coefficient is then calculated for the conditions at time t_{b} as:

$${k}_{d} = \frac{α {X}_{o}}{2 {A}_{b} {Q}_{b} {R}_{b}} \qquad ( 9 )$$

where A_{b} is the active surface area of filter 504 and R_{b} is the overall resistance at t_{b}.

A general model was proposed by Liu (1992) for MF cross-flow filtration. This model takes into account three different particle fractions: the particles 520 which are deposited against the membrane surface (see FIG. 5), the particles 522 which contribute to an internal clogging of pores 505, and the particles 524 which are transported from the deposit to the bulk of the liquid phase. The filtration flow-rate at any time is then given as a function of t and volume V as follows:

$$\frac{{Q}_{o}}{Q} = {k}_{d 1} ( V - {k}_{b f} t ) + \frac{1}{{[ 1 - {k}_{i} ( V - {k}_{b f} t ) ]}^{2}} \qquad ( 10 )$$

where K_{d1}, K_{bf} and Kᵢ are linked to the deposition (cross-flow mode), the back-transport (as explained above) and the standard (internal) clogging, respectively.

This model predicts a steady flow rate (Qₛ) when (V−K_{bf} t) becomes constant (see Elmaleh and Ghaffor, 1996) as shown in equation (11):

$$\frac{{Q}_{s}}{{Q}_{o}} = \frac{1}{1 + {k}_{d 1} {V}_{s}} \qquad ( 11 )$$

with Vₛ=V−K_{bf} t.

The parameters K_{d1}, K_{bf} and Kᵢ are linked to the operational full rejection conditions by the following equations (see, Liu):

$${k}_{d 1} = \frac{α {X}_{o}}{A {R}_{m}} , {k}_{b f} = \frac{{Q}_{b f}}{{X}_{o}} and {k}_{i} = \frac{2 {X}_{o}}{N {r}_{o}^{2} L} \qquad ( 12 )$$

where rₒ is the initial pore 505 radius, L is the pore's length, and N is the number of pores in the membrane 504. The back-transport flow-rate at steady state (Q_{bf}) was also introduced as a limiting convective flux (see, Chudacek and Fane, 1984).

It can be shown that a relation between the deposition coefficient of dead-end k_{d} (see Equation (7)) and the cross-flow k_{d1} (see Equation 12), exists as follow:

$$\frac{{Q}_{o}}{Q} = {k}_{d 1} V + 1 . \qquad ( 13 )$$

Because the flow rate Q is defined as Q=dV/dt, after integration of equation (13), the following is obtained:

$$\frac{t}{V} = \frac{1}{{Q}_{o}} + \frac{1}{2} \frac{{k}_{d 1}}{{Q}_{o}} V . \qquad ( 14 )$$

By comparing Equation (14) to the cake deposition model (Equations 6 and 7), the following relation is obtained:

$${k}_{d} = \frac{{k}_{d 1}}{2 {Q}_{o}} . \qquad ( 15 )$$

A difference between the MFI approach and this novel approach is the exclusive use in the MFI approach of the transient state for the cake deposition model whereas the present approach uses the back-transport, which permits to consider both transient and steady state regimes.

Because for a real scale RO process, internal fouling and partial clogging do not occur (foulants cannot penetrate the membrane structure) due to the nature of the membrane (dense layer), these aspects are eliminated (i.e., coefficient Kᵢ is nil). The dominant fouling in RO is the deposition of the foulants on the membrane surface (i.e., particles 520 in FIG. 5). Therefore, Equation (10) becomes:

$$\frac{\frac{{Q}_{o}}{Q} - 1}{V} = {k}_{d 1} - {k}_{d 1} {k}_{b f} \frac{t}{V} . \qquad ( 16 )$$

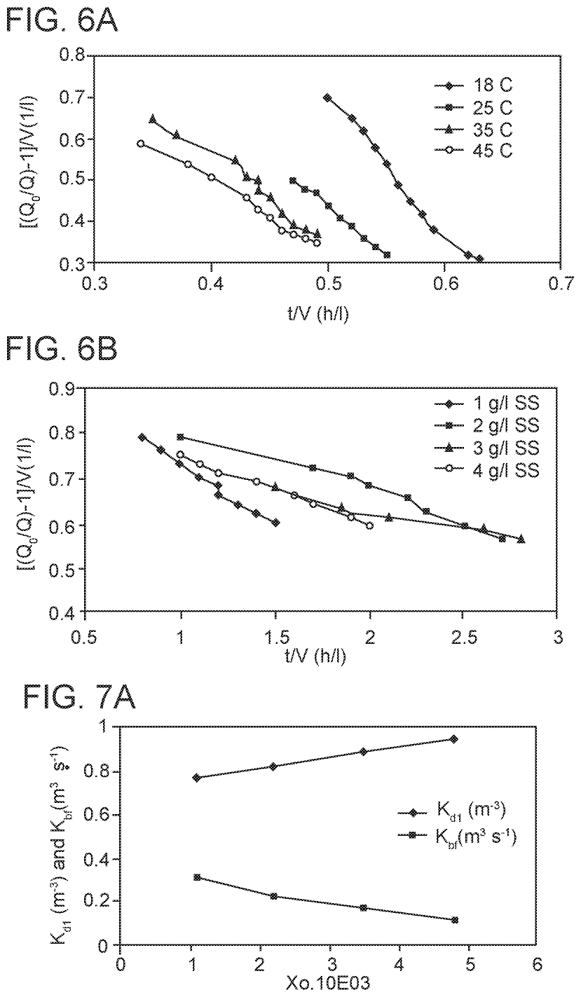

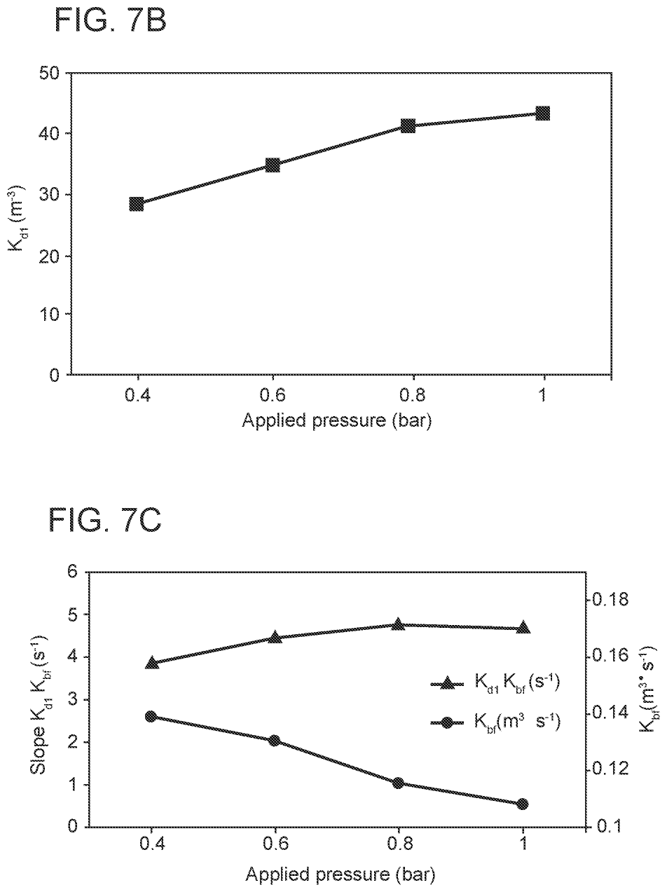

If quantity ((Qₒ/Q)−1)/V is plotted versus t/V for various operating parameters, e.g. temperature, concentration of the water feed or applied pressure, according to equation (16), the ROFix index is the slope of the straight lines (K_{d1}K_{bf}) that fit the experimental data shown in FIG. 6A or could be represented by a parameter related to the slope, i.e., the deposition coefficient (K_{d1}), or the back-transport coefficient (K_{bf}), both obtained from the slope. Thus, the straight line that corresponds to the experimental data allows to calculate both the k_{d1} (m⁻³) and the k_{bf} (m³/s) fouling parameters. Parameters α (i.e., cake specific resistance per unit length of deposit in m⁻²) and Q_{bf} (m³/s) can be derived from equation (12). The ROFix model fits satisfactorily with the data obtained for different operating conditions. FIG. 6B shows the experimental data for various amounts of suspended solids (SS) in the water. Again, a linear fit to the experimental data allows the calculation of the intercept and the slope, which is the ROFix index. The two fouling parameters k_{d1} and k_{bf} when plotted versus the feed concentration as an example, as shown in FIG. 7A, exhibit a linear behavior. Note that in order to calculate the slope of equation (16), only the filtrate volume V at various times t is necessary, to calculate the filtrate flow rate Q at any time. Further, an initial filtrate flow rate Q₀ needs to be measured. Using the flowmeters discussed in FIG. 5, and the timer associated with the processor 518, the ROFix device 500 is capable to collect experimental data while the feed is flowing over the membrane 504. Having this data, processor 518 is capable of calculating the ROFix index. FIG. 7B illustrates the dependence of the deposition parameter k_{d1} with the applied pressure and FIG. 7C illustrates the dependence of the slope K_{d1}K_{bf} and K_{bf} with the applied pressure. It is noted that the trend of the deposition parameter and the slope with the applied pressure is similar to that of the deposition parameter and the slope with the feed concentration.

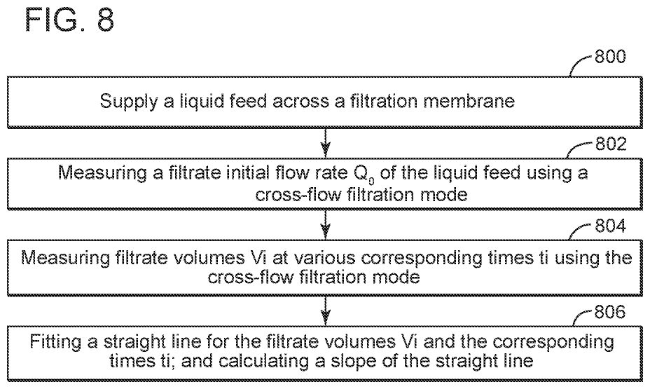

A method for calculating the ROFix index for a given feed and a given membrane is now discussed with regard to FIG. 8. The method includes a step 800 of supplying a liquid feed across a filtration membrane, a step 802 of measuring an initial filtrate flow rate Q₀ of the liquid feed using a cross-flow filtration mode, a step 804 of measuring (804) filtrate volumes Vᵢ at various corresponding times tᵢ using the cross-flow filtration mode, a step 806 of fitting a straight line for the filtrate volumes Vᵢ and the corresponding times tᵢ; and a step 810 of calculating a slope of the straight line. The ROFix index is deducted or determined from the slope and the cross-flow filtration mode allows the liquid feed to exit the filtration system.

FIG. 9 depicts an apparatus 900 in which the method for determining the ROFix index described herein can be implemented. The apparatus 900 can be embodied in any one of a wide variety of wired and/or wireless computing devices, multiprocessor computing device, and so forth. As shown in FIG. 9, the apparatus 900 comprises a memory 902, a processing device 904, a number of input/output interfaces 906, a network interface 908, a display 910, a peripheral interface 912, and mass storage 914, where each of these devices are connected across a local data bus 916. The apparatus 900 can be coupled to one or more peripheral measurement devices (e.g., flowmeter 516 and/or 516′), which are connected to the apparatus 900 via the peripheral interface 912. The apparatus 900 shown in FIG. 9 may be implemented as the processor 518 in FIG. 5.

The processing device 904 may include any custom made or commercially available processor, a central processing unit (CPU) or an auxiliary processor among several processors associated with the apparatus 900, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system.

The memory 902 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 902 typically comprises a native operating system 903, one or more native applications, emulation systems, or emulated applications for any of a variety of operating systems and/or emulated hardware platforms, emulated operating systems, etc. For example, the applications may include application specific software which may be configured to perform the ROFix index. In accordance with such embodiments, the application specific software is stored in memory 902 and executed by the processing device 904. One of ordinary skill in the art will appreciate that the memory 902 can, and typically will, comprise other components which have been omitted for purposes of brevity.

Input/output interfaces 906 provide any number of interfaces for the input and output of data. For example, where the apparatus 900 comprises a personal computer, these components may interface with one or more user input devices 912. The display 910 may comprise a computer monitor, a plasma screen for a PC, a liquid crystal display (LCD) on a hand held device, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

With further reference to FIG. 9, network interface device 908 comprises various components used to transmit and/or receive data over a network environment. For example, the network interface 908 may include a device that can communicate with both inputs and outputs, for instance, a modulator/demodulator (e.g., a modem), wireless (e.g., radio frequency (RF)) transceiver, a telephonic interface, a bridge, a router, network card, etc.). The apparatus 900 may communicate with one or more computing devices via the network interface 908 over a network. The apparatus 900 may further comprise a mass storage 914.

The flow chart of FIG. 8 shows an example of functionality that may be implemented in the apparatus 900 of FIG. 9. If embodied in software, each block shown in FIG. 8 may represent a module, segment, or portion of code that comprises program instructions to implement the specified logical function(s). The program instructions may be embodied in the form of source code that comprises machine code that comprises numerical instructions recognizable by a suitable execution system such as the processing device 904 in a computer system or other system. The machine code may be converted from the source code, etc. If embodied in hardware, each block may represent a circuit or a number of interconnected circuits to implement the specified logical function(s).

Although the flow chart of FIG. 8 shows a specific order of execution, it is understood that the order of execution may differ from that which is depicted. For example, the order of execution of two or more blocks may be scrambled relative to the order shown. Also, two or more blocks shown in succession in FIG. 8 may be executed concurrently or with partial concurrence. Further, in some embodiments, one or more of the blocks shown in FIG. 8 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processing device 904 in a computer system or other system. In this sense, each may comprise, for example, statements including instructions and declarations that can be fetched from the computer-readable medium and executed by the instruction execution system.

The present disclosure is directed to systems and methods relating to estimating membrane fouling. In an embodiment, a reverse osmosis fouling index (ROFix) or reverse osmosis (RO) fouling indices are provided to predict fouling in an RO system. The index can be used to determine a proper course of pretreatment of feed to an RO system.

In various aspects, the novel ROFix index can be used to reproducibly and precisely predict fouling of reverse osmosis (RO) membranes. In certain embodiments, ROFix can be used to monitor performance of RO membranes, stand-alone or as part of a system, and can be used to monitor aspects of the system such as pretreatment efficiency or fouling tendency of pretreatment effluent for RO feed systems. Membranes subject to ROFix analysis can either be standalone or part of a larger RO system, such as a desalinization plant.

The present ROFix system and method can analyze permeate, or filtrate, provided to the reverse osmosis system as a liquid feed to the membrane in the system. The present ROFix system and method can analyze the flux of the permeate, or filtrate, filtered by one or more reverse osmosis membranes undergoing cross-flow filtration. The ROFix device discussed above can analyze permeate flux filtered by one or more reverse osmosis membranes undergoing a mix of dead-end filtration and cross-flow filtration. ROFix can analyze the fouling tendency of pretreatment effluent for an RO feed system, and can analyze permeate fluxes in other parts of an RO system or RO pathway. ROFix analysis can include cross-flow filtration dynamics and/or kinetics. ROFix analysis can take into account transient and steady state flux dynamics and/or kinetics of permeate flux undergoing cross-flow filtration. ROFix analysis can take into account specific properties relating to cross-flow filtration of permeate flux, such as cross-flow deposition and back-transport.

In an embodiment, ROFix can be determined using: initial filtrate flow rate Q₀, filtrate flow rate Q, volume of filtrate V, and a time t. In another embodiment, more parameters may be used for calculating the ROFix, e.g., the back-transport rate at steady state, the volumetric particles in suspension, cake-specific resistance per unit length of deposit, membrane surface area, and membrane resistance. In an embodiment, a specific ROFix value can be determined by calculating the slope of a line obtained by plotting ((initial filtrate flow rate/filtrate flow rate)−1)/volume of filtrate) versus t/V according to equation (16).

ROFix can use cross-flow deposition of a membrane and cross-flow back-transport through the membrane as fouling parameters to predict fouling of a membrane. ROFix can generate data relating to fouling parameters, such as cross-flow deposition and cross-flow back-transport. ROFix can determine parameters of permeate or filtrate feed relating to cross-flow deposition on the membrane and cross-flow back-transport through the membrane. The fouling parameter cross-flow deposition as used in the ROFix analysis can be determined with the cake specific resistance per unit length of deposition on the membrane, the volumetric particles in suspension in the filtrate feed, the membrane surface area, and the membrane-specific resistance. The fouling parameter of back flow as used in ROFix analysis can be determined using the back-transport flow rate through the membrane at steady state and the volumetric particles in suspension in the filtrate.

Described herein is a system for determining ROFix, which can also be described as an ROFix system. The system can analyze the fouling tendency of pretreatment effluent for an RO feed system, and can analyze permeate or filtrate fluxes in other parts of an RO system or RO pathway. In an embodiment, the system can utilize a cross-flow flat sheet filtration cell and can use one or more membranes (such as microfilters, ultrafilters, and/or nanofilters) with different pore sizes. The system can use membranes with varying pore sizes to target different types of foulants (such as particulate, colloidal, and/or organic) by size exclusion. An ROFix system can use different pore size membranes for the same water quality test to increase accuracy, depending on the response of the flux or pressure evolution trends.

The system can be run in different modes. In one or more aspects, the system can analyze or determine permeate (filtrate) flux through one or more membranes under constant feed pressure. The system can therefore be configured to analyze permeate (filtrate) flux under constant feed pressure, representing one mode. The system can analyze permeate flux through one or more membranes under constant permeate flux. The system can also therefore be configured to analyze permeate flux under constant permeate flux, representing another mode.

The system can also optionally determine membrane surface area, specific membrane resistance, and cake-specific resistance per unit length of deposit, and generate data relating to these parameters. The system can be configured to send these data to an apparatus. The apparatus can be computing as described further herein.

The apparatus can use the fouling parameters of cross-flow deposit and back transport to determine ROFix. The apparatus can determine cross flow deposit fouling by multiplying (cake-specific resistance per unit length of deposit) (volumetric particles in suspension). The multiplied value can be divided by the product of (membrane area)*(membrane resistance) to generate a value for cross flow deposit fouling. The apparatus can determine back transport fouling by dividing the back-transport flow rate at steady state by the volumetric particles in suspension. In an embodiment, a representative equation that can be used by the apparatus for ROFix determination can be ((initial filtrate flow rate/filtrate flow rate)−1)/(filtrate volume)=(cross flow deposit)−(cross flow deposit)(back transport)(time/filtrate volume). The apparatus can plot ((initial filtrate flow rate/filtrate flow rate)−1)/(filtrate volume) versus (time/filtrate volume), and determine ROFix as the slope of the line[s] (K_{d1}K_{bf}) generated from the plot or could be represented by the deposition coefficient (K_{d1}), or the back-transport coefficient (K_{bf}) obtained from the slope (K_{d1}K_{bf}).

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

### REFERENCES

S. F. E. Boerlage, M. D. Kennedy, P. A. C. Bonne, G. Galjaard, J. C. Schippers, Prediction of flux decline in membrane systems due to particulate fouling, Desalination 113 (1997) 231-233.
S. F. E. Boerlage, M. D. Kennedy, I. Bremere, G. J. Witkamp, J. P. Van Der Hoek, J. C. Schippers, The modified fouling index using ultrafiltration membranes (MFI-UF): characterisation, filtration mechanisms and proposed reference membrane, Journal of Membrane Science 197(2002) 1-21.
S. Khirani, R. Ben Aim and M.-H. Manero, Improving the measurement of the Modified Fouling Index using nanofiltration membranes (NF-MFI), Desalination 191 (2006) 1-7.
K. Hong, S. Lee, S. Choi, Y. Yu, S. Hong, J. Moon, J. Sohn, J. Yang, Assessment of various membrane fouling indexes under seawater conditions, Desalination 247 (2009) 247-259.
Y. Yu, S. Lee, K. Hong, S. Hong, Evaluation of membrane fouling potential by multiple membrane array system (MMAS): Measurements and applications, Journal of Membrane Science 362 (2010) 279-288.
J.-S. Choi, T.-M. Hwang, S. Hong, A systematic approach to determine the fouling index for a RO/NF membrane process, Desalination 238(2009) 117-127.
S. F. E. Boerlage, M. Kennedy, Z. Tarawneh, R. De Faber, J. C. Schippers, Development of the MFI-UF in constant flux filtration, Desalination 161(2004) 103-113.
S. Salinas, N. Ghaffour, M. Kennedy, J. Schippers, G. Amy, New concepts in fouling indices, AWWA/AMTA Membrane Technology Conference, Feb. 27-Mar. 1, 2012, Phoenix, USA.
L. N. Sim, Y. Ye, V. Chen, A. G. Fane, Crossflow Sampler Modified Fouling Index Ultrafiltration (CFS-MFIUF)—An alternative Fouling Index, Journal of Membrane Science 360(2010) 174-184.
S. S. Adham and A. G. Fane, Crossflow Sampler Fouling Index, National Water Research Institute, California, USA, 2008.
M. A. Javeed, K. Chinu, H. K. Shon, S. Vigneswaran, Effect of pre-treatment on fouling propensity of feed as depicted by the modified fouling index (MFI) and cross-flow sampler-modified fouling index (CFS-MFI), Desalination 238(2009) 98-108.
L. N. Sim, Y. Ye, V. Chen, A. G. Fane, Comparison of MFI-UF constant pressure, MFI-UF constant flux and Crossflow Sampler-Modified Fouling Index Ultrafiltration (CFS-MFIUF), Water Research 45(2011) 1639-1650.
J. Herima, Constant pressure blocking filtration laws. Application to power-law non-newtonian fluids, trans. Ind. Chem. Eng., 60 (1982) 183-187.
G. Bolton, D. LaCasse, R. Kuriyel, Combined models of membrane fouling: Development and application to microfiltration and ultrafiltration of biological fluids. Journal of Membrane Science 277 (2006) 75-84.
R. Villaroel-Lopez, S. Elmaleh, N. Ghaffor, Cross-flow ultrafiltration of hydrocarbons emulsions, Journal of Membrane Science 102 (1995) 55-64.
M. G. Liu, Etude de la texture des Membranes et de leur Interaction avec des Suspensions au cours d'une filtration dynamique, Ph.D. thesis, Université de Compiègne, France, 1992.
S. Elmaleh, N. Ghaffor. Cross-flow ultrafiltration of hydrocarbons and biological solid mixed suspensions, Journal of Membrane Science 118 (1996) 111-120.
M. W. Chudacek, A. G. Fane, The dynamics of polarization in unstirred and stirred ultrafiltration, Journal of Membrane Science 21 (1984) 145.

1. A method for determining a fouling index ROFix in a filtration system, the method comprising:
supplying a liquid feed across a filtration membrane;
measuring an initial filtrate flow rate Q₀ of the liquid feed using a cross-flow filtration mode;
measuring filtrate volumes Vᵢ at various corresponding times tᵢ using the cross-flow filtration mode;
fitting a straight line for the filtrate volumes Vᵢ and the corresponding times tᵢ; and
calculating a slope of the straight line,
wherein the slope or a parameter related to the slope is the ROFix index, and
wherein the cross-flow filtration mode allows the liquid feed to exit the filtration system.

2. The method of claim 1, wherein the parameter related to the slope is a deposition coefficient (K_{d1}) or a back-transport coefficient (K_{bf}), and the slope (K_{d1}K_{bf}) is the product of the deposition coefficient and the back-transport coefficient.

3. The method of claim 1, wherein the cross-flow filtration mode has an input and first and second outputs.

4. The method of claim 3, wherein the input corresponds to the fluid feed, the first output corresponds to the filtrate and the second output corresponds to a part of the fluid feed that passes over the membrane.

5. The method of claim 1, further comprising:
calculating an intercept of the straight line as a first fouling parameter k_{d1}.

6. The method of claim 5, wherein the first fouling parameter k_{d1} corresponds to a cross-flow of the liquid feed.

7. The method of claim 5, further comprising:
dividing the slope of the straight line by the intercept to calculate a second fouling parameter k_{bf}.

8. The method of claim 7, wherein the second fouling parameter k_{bf} corresponds to a back-transport of the filtrate.

9. The method of claim 1, wherein the cross-flow filtration mode is characterized by a transient regime, a steady state regime, and a limiting regime.

10. The method of claim 9, wherein the transient regime has a decreasing permeate flux, the steady state regime has the permeate flux reaching a plateau, and the limiting regime has the permeate flux independent of an applied pressure.

11. The method of claim 1, further comprising:
applying a predetermined pressure to the liquid feed.

12. A reverse osmosis fouling index (ROFix) device comprising:
a storing container storing a liquid feed to be filtered;
a filtering container holding a filtration membrane to be tested for fouling, the filtering container being in fluid communication with the storing container;
a flowmeter for measuring a flow rate of the liquid feed;
a manometer for measuring a pressure at an inlet of the filtering container and at an outlet of the filtering container; and
a processor connected to the flowmeter and the manometer and configured to calculate a ROFix index based on (i) an initial filtrate flow rate Q₀ of the liquid feed using a cross-flow filtration mode and (ii) plural filtrate volumes Vᵢ measured at various corresponding times tᵢ.

13. The device of claim 12, wherein the processor fits a straight line for the filtrate volumes Vᵢ and the corresponding times tᵢ and calculates a slope of the straight line.

14. The device of claim 13, wherein the slope or a parameter related to the slope is the ROFix index, the parameter related to the slope is a deposition coefficient (K_{d1}) or a back-transport coefficient (K_{bf}) and the slope (K_{d1}K_{bf}) is the product of the deposition coefficient and the back-transport coefficient, and the cross-flow filtration mode allows the liquid feed to exit the filtering container.

15. The device of claim 12, wherein the ROFix device is a cross-flow filtration system that predicts fouling in a reverse osmosis system.

16. The device of claim 12, wherein the filtering container has an input and first and second outputs.

17. The device of claim 16, wherein the input corresponds to the fluid feed, the first output corresponds to the filtrate and the second output corresponds to a part of the fluid feed that passes over the membrane.

18. The device of claim 13, wherein the processor calculates an intercept of the straight line as a cross-flow parameter k_{d1}.

19. The device of claim 18, wherein the processor divides the slope of the straight line by the intercept to calculate a back-transport parameter k_{bf}.

20. A non-transitory computer readable medium including computer executable instructions, wherein the instructions, when executed by a processor, implement instructions for determining a fouling index ROFix in a filtration system, the instructions comprising:
instructing a pump to supply a liquid feed across a filtration membrane;
instructing a flowmeter to measure an initial filtrate flow rate Q₀ of the liquid feed using a cross-flow filtration mode;
instructing the processor to measure filtrate volumes Vᵢ at various corresponding times tᵢ using the cross-flow filtration mode;
instructing the processor to fit a straight line for the filtrate volumes Vᵢ and the corresponding times tᵢ; and
instructing the processor to calculate a slope of the straight line,
wherein the slope or a parameter related to the slope is the ROFix index,
wherein the cross-flow filtration mode allows the liquid feed to exit the filtration system, and
wherein the parameter related to the slope is a deposition coefficient (K_{d1}) or a back-transport coefficient (K_{bf}) and the slope (K_{d1}K_{bf}) is the product of the deposition coefficient and the back-transport coefficient.
